(19) United States
(12) Patent Application Publication
(10) Pub. No.: US 2005/0119969 A1
(43) Pub. Date: Jun. 2, 2005

(54) Money transfer notification systems and methods

(75) Inventors: Michael J. Michelsen, Arvada, CO (US); Mark Thompson, Denver, CO (US); Margaret Lapkin, Glen Rock, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/987,201

(22) Filed: Nov. 12, 2004

Related U.S. Application Data
(63) Continuation-in-part of application No. 10/890,821, filed on Jul. 13, 2004.
Application No. 10/890,821 is a continuation-in-part of application No. 10/394,603, filed on Mar. 21, 2003, now Pat. No. 6,761,311.

(51) Int. Cl. G06F 17/60

(52) U.S. Cl. 705/39

(57) ABSTRACT

A method of transferring funds from a sender to a recipient includes receiving, at a transfer location, a transfer request from the sender. The transfer request includes a notification request to notify the sender when the recipient receives the funds. The method also includes sending the transfer request to a host computer system, receiving, at a transfer location, a request from the recipient to receive the funds, receiving a message at the host computer system that the recipient received the funds, and sending from the host computer system a notification to the sender that the recipient received the funds.

CROSS-REFERENCES TO RELATED APPLICATIONS

This application is a continuation-in-part of, and claims the benefit of, co-pending, commonly-assigned U.S. patent application Ser. No. 10/890,821 (Attorney Docket No. 020375-27410), entitled, “SYSTEM AND METHODS FOR DISCLOSING TRANSACTION INFORMATION TO CUSTOMERS,” filed on Jul. 13, 2004, by Algiene, et al., which is a continuation-in-part of, and claims the benefit of commonly-assigned U.S. patent application Ser. No. 10/394,603 (now U.S. Pat. No. 6,761,311, issued on Jul. 13, 2004) entitled, “SYSTEM AND METHODS FOR DISCLOSING TRANSACTION INFORMATION TO CUSTOMERS,” filed on Mar. 21, 2003, by Algiene, et al., the entire disclosure of each of which is herein incorporated for all purposes.

### BACKGROUND OF THE INVENTION

The present invention relates generally to notification systems. More specifically, the present invention relates to systems and methods for notifying one or more parties having an interest in a financial transaction that certain events have taken place.

Money transfer systems are well known. Many people use the services of money transfer service providers to send funds to other people or businesses. Electronic communication and banking networks now allow such transactions to have nearly global reach. Present money transfer systems could be improved, however, if the parties to the transaction received more information about the progress of the transaction. For example, it would be helpful for the recipient to know that money has been sent to them and it would be helpful for the sender to know when the recipient has received the money. The present invention addresses these and other limitations of present systems.

### BRIEF SUMMARY OF THE INVENTION

Embodiments of the invention thus provide a method of transferring funds from a sender to a recipient. The method includes receiving, at a transfer location, a transfer request from the sender. The transfer request includes a notification request to notify the sender when the recipient receives the funds. The method also includes sending the transfer request to a host computer system, receiving, at a transfer location, a request from the recipient to receive the funds, receiving a message at the host computer system that the recipient received the funds, and sending from the host computer system a notification to the sender that the recipient received the funds.

In some embodiments, the notification to the sender may be an email, telephone call, text message, letter, telegram, and/or the like. The telephone call may not be received by the sender, in which case the method may include attempting to contact the sender a plurality of times over a specified period of time. The method also may include leaving a message on a voice message system of the sender.

In other embodiments, a method of transferring funds from a sender to a recipient includes receiving, at a transfer location, a transfer request from the sender. The transfer request includes a notification request to notify the recipient that funds are available for pick up. The message also includes sending the transfer request to a host computer system and sending a message from the host computer system to the recipient that the funds are available for pick up. The message to the recipient may include a selection for the recipient to opt out of future notifications. The message to the recipient may be an email, telephone call, text message, letter, telegram, and/or the like. The method also may include receiving, at a transfer location, a request from the recipient to receive the funds, receiving a message at the host computer system that the recipient received the funds, and sending from the host computer system a message to the sender that the recipient received the funds.

In still other embodiments, a system for notifying parties to a transfer of value includes a host computer system configured to receiving a request to transfer value from a sender to a recipient. The request includes information that identifies the recipient, the form of value, and instructions to notify a party to the transaction when an event has occurred. The system also includes a notification unit configured to comply with the notification request and a least one transfer location configured to receive value from a sender and remit value to a recipient. The value may be money, airline miles, credits, long distance time, wireless telephone minutes, movie rentals, customer loyalty points, and/or the like. The transfer location may include a point-of-sale device, personal computer, automated teller machine, multi-purpose kiosk, and/or the like. The notification unit may be configured to place a telephone call to one of the parties, leave a message if a voice mail system answers the call, place multiple calls until a person or a voice mail system answers, and provide an automated human voice message to an answering party. If the value includes money, the notification request may include a request from the sender to be notified when the recipient receives the money.

In still other embodiments, a computer-readable medium includes instructions for performing a method. The method includes receiving a value transfer request from a sender, storing at least a portion of the request as a transfer, receiving a message that a recipient has received the value, and notifying a party to the transaction regarding the progress of the transaction.

In some embodiments, a method of transferring value includes, at a first transfer location, receiving a request to transfer value. The request includes information that identifies the recipient, the form of value, and instructions to notify a party to the transaction when an event has occurred. The method also includes sending at least a portion of the information to a host computer system and, at a second transfer location, receiving a request from the recipient to receive the value. The method also includes fulfilling the receive request and complying with the notification instruction. Complying with the notification instruction may include notifying the recipient that value is available for receipt. Complying with the notification instruction may include notifying the sender that the recipient received the value.

In still other embodiments, a method of providing one or more notifications to one or more parties related to a transaction includes, at a first point-of-sale, receiving transaction initiation information from a first party to the transaction, sending the transaction initiation information to a host computer system, creating a record at the host computer system relating to the transaction, and, at a second point-of-sale, receiving transaction settlement information from a second party. The transaction settlement information may be used to settle at least a portion of the transaction. The method also includes sending the transaction settlement information to the host computer system and updating the record at the host computer system. The transaction initiation information or the transaction settlement information may include a notification request. The method also includes storing information relating to the notification request in the record at the host computer system and complying with the notification request. The first party and the second party may be the same party. Storing information relating to the notification request in the record at the host computer system may include storing a multimedia file created by either the first party or the second party. Complying with the notification request may include sending a message to a sender that a recipient has picked up money, sending a message to a recipient that a sender has deposited money for the recipient to pick up, sending information to a third party relating to the transaction, sending a message to a card holder that a balance is below a pre-determined threshold, sending a message to an account holder that a balance is below a pre-determined threshold, sending transaction activity information to a party, sending a personalized message from one of the parties to another of the parties, and/or the like. The transaction basis may include a measure of value such as money, airline miles, credits, long distance time, wireless telephone minutes, movie rentals, customer loyalty points, and/or the like. Complying with the notification request may include sending a notification in a form such as email, telephone call, text message, letter, telegram, and/or the like.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a money transfer system according to embodiments of the present invention.

FIG. 2 illustrates a money transfer process according to embodiments of the invention.

FIG. 3 illustrates several exemplary recipient and sender notifications according to embodiments of the invention.

### DETAILED DESCRIPTION OF THE INVENTION

According to embodiments of the present invention, parties to or interested in a financial transaction may receive notifications relating to particular steps in the process. For example, a sender in a money transfer transaction may request to be notified when the recipient to whom the sender is sending money picks up the money. The sender may request to be notified by phone, facsimile, email, letter, instant message, telegram, or the like. Attempted notifications may continue until the sender receives actual notification, until a specified time passes, or the like. Notification attempts also may end if the sender's voice mail or answering machine accepts a message. The sender may specify any of these preferences at the time of initiating a transfer or may establish a profile that includes the preferences. In another example, the sender may request to be notified after a specified period of time that the recipient has not picked up the money. The notifications may continue until the recipient does pick up the money.

The sender also may request that the recipient receive notification. The notification to the recipient may be by any of the means previously described. The recipient's notification also may be triggered by a profile established by the recipient. In such cases, even if the sender does not specify sending a notification to the recipient, the recipient may nevertheless receive one by virtue of the pre-established profile.

Recipients also may initiate one or more notifications, for example to the sender in a money transfer transaction or to another interested party. As an example, the recipient may wish to send a “thank you” message to the sender. If the recipient is a collection agent of a creditor, the recipient may wish to send a notification to the creditor and/or the sender that a payment has been received. Other examples are possible.

Embodiments of the invention also provide for notifying third parties. For example, if a person pays a creditor on behalf of a debtor, the debtor may be notified that the creditor has received the money. As another example, if a sender (e.g., debtor) transfers money to a third party (e.g., collections agent) for the benefit of a creditor, the sender may request that the creditor be informed that the sender has initiated the transfer. The creditor may then act on the information, for example, by suspending eviction proceedings. In any case—sender notification, recipient notification, third party notification—the notification may include instructions the notified party may follow to alter future notifications or opt out of notifications all together.

In some embodiments, it is not necessary for one or more parties to request the notification. Parties may be notified as a rule. The parties, however, may opt out of receiving notifications, as will be described.

In some embodiments, notifications may include audio and/or video. These notifications may be recorded by one party to be sent to another party. In this way, message may be more personalized.

Notifications according to embodiments of the invention may take different forms and may relate to other services. In one example, a sender transfers money to himself to be withdrawn periodically as the sender desires. Such transactions are useful for travel to avoid having to carry sums of cash. The sender may request to be notified when his balance falls below a particular threshold. In another example, a customer deposits a sum of value to a presentation instrument or account, such as a gift card, a stored value card, a prepaid services account, or the like. The customer may request to be notified when the available balance falls below a predetermined threshold. In another example, a customer may request to receive a periodic summary of activity relating to a money transfer transaction.

While the present invention will be described in the context of a money transfer system, this is not to be considered limiting. Embodiments of the invention may be used with systems for transferring other forms of value, including, for example, miles, loyalty points, credits, and the like. Further, embodiments of the invention also relate to notifications to a card holder (e.g., a stored value card), that the card has been used, that the balance is below a pre-determined threshold, that a nearby facility may be used to add value, and the like. Further still, the systems and methods described herein may be used to send other forms of notifications, such as marketing messages and the like. Those skilled in the art will recognize many other possibilities in light of this disclosure.

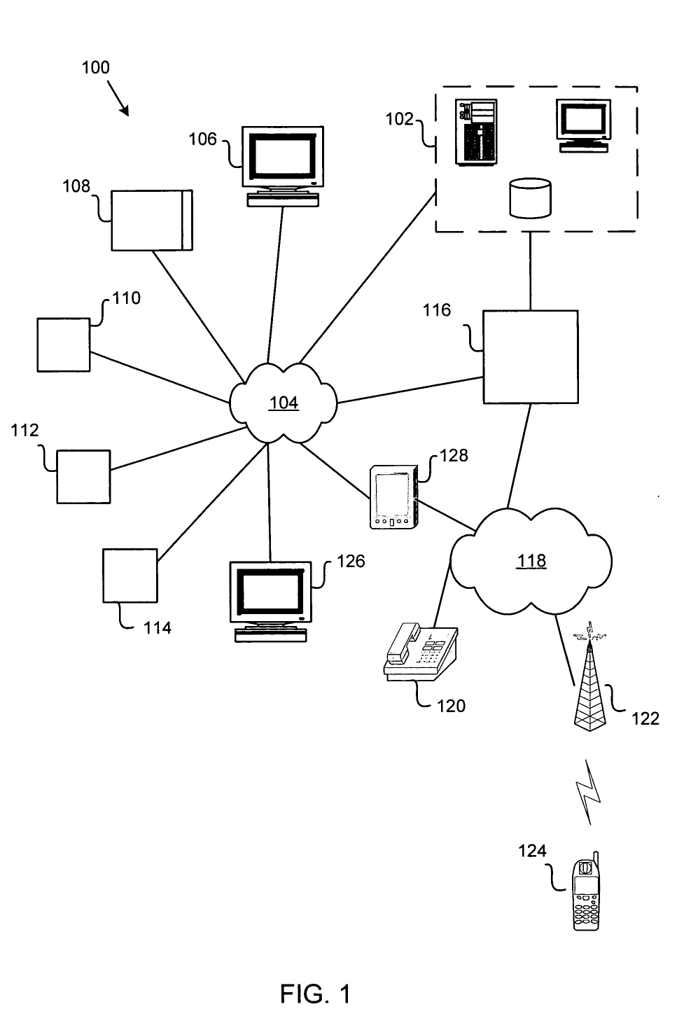

Having described embodiments of the present invention generally, attention is directed to FIG. 1, which illustrates a money transfer system 100 according to embodiments of the present invention. The system 100 is not to be considered limiting. Embodiments of the present invention may be embodied in the system 100 or other suitable system.

The system 100 includes a host computer system 102 and a network 104. The host computer system 102 may include, for example, server computers, personal computers, workstations, web servers, and/or other suitable computing devices. The host computer system 102 includes application software that programs the host computer system 102 to perform one or more functions according to the present invention. For example, application software resident on the host computer system 102 may program the host computer system 102 to process money transfer records according to embodiments of the present invention. The host computer system 102 may include one or more of the aforementioned computing devices, as well as storage devices such as databases, disk drives, optical drives, and the like. The storage devices may include solid state memory, such as RAM, ROM, PROM, and the like, magnetic memory, such as disc drives, tape storage, and the like, and/or optical memory, such as DVD. The host computer system 102 may be fully located within a single facility or distributed geographically, in which case a network may be used to integrate the host computer system 102. Many other examples are possible and apparent to those skilled in the art in light of this disclosure.

The network 104 may be the Internet, an intranet, a wide area network (WAN), a local area network (LAN), a virtual private network, any combination of the foregoing, or the like. The network 104 may include both wired and wireless connections, including optical links. In some embodiments, the network 104 is a money transfer network. Through the network 104, transaction devices communicate with the host computer system 102.

The system 100 also includes one or more transaction processing devices 106, 108, 110, 112, 114. Transaction processing devices may be any of a number of devices capable of receiving money transfer requests from a sender and/or dispensing money to a recipient. A transaction processing device may be, for example, a personal computer 106 or other computing device. The personal computer 106 may be any of a variety of computing devices such as a personal computer, laptop computer, desktop computer, personal digital assistant (PDA), or the like. Using such a device, a sender may initiate a money transfer request that is settled from the sender's checking or savings account, credit card, or the like.

The system 100 also includes a point-of-sale (POS) device 108. POS devices are more fully described in U.S. Pat. No. 6,547,132, issued on Apr. 15, 2003, the entire disclosure of which is incorporated herein by reference for all purposes. Essentially, POS devices are terminals for receiving transaction information and sending the information to a host computer system. For example, a POS may receive transaction information by capturing it from a card using a reader integral to or associated with the POS. A POS also may receive information from an attendant or customer via a keypad, keyboard, and/or other input device. Other examples are possible. POS devices are typically located at money transfer service provider locations. POS devices such as the POS 108 may be attended or unattended. Because POS devices such as those described herein typically are not configured to dispense funds, unmanned POS devices typically are not used for receive transactions. Such POS devices, however, may be used by a recipient to redirect funds to an account or another recipient.

The system 100 also may include one or more computing devices 110 programmed to receive money transfer information from customers or attendants. The computing device 110 may be any of the aforementioned computing devices. Like the POS devices 108, the computing devices 108 may be located at money transfer service provider locations. At such locations, an attendant usually enters the money transfer information after the customer (sender or recipient) has completed an appropriate money transfer form.

The system also may include one or more Customer Service Representative (CSR) computers 112. The CSR computers 112 may be located, for example, at a call center operated by a money transfer service provider. The CSR computers 112 function much like the POS devices 108 and/or the computing devices 110, except that transaction information is entered by a CSR who is receiving the information from a customer by phone, for example. In some examples, a voice response unit may receive some or all of the information.

The system 100 also may include one or more unmanned transaction devices 114 such as a multi-purpose kiosk or an automated teller machine (ATM). ATMs are well known; kiosks are more fully described in co-pending, commonly assigned U.S. patent application Ser. No. 10/225,410 (filed on Aug. 20, 2002, the entire disclosure of which is incorporated herein by reference for all purposes). Unmanned transaction devices 114, such as kiosks and ATMs, may be used for both send and receive transactions since such devices typically are configured to dispense cash, money orders, and/or other forms of value.

According to the present invention, a customer presents himself to a money transfer location. The location may be equipped with any of the aforementioned devices, which include a personal computer at the sender's home. The sender enters transaction information into the transaction processing device, completes a form that an attendant uses to enter information into a transaction processing device, provides the information verbally to an attendant, either in person or remotely, by phone for example, and/or the like. In some embodiments, the customer provides some or all of the information by presenting a loyalty card or other personal information card that has the information stored on it or serves to identify an account from which the information may be obtained. The transaction information includes an amount of value to be transferred, a recipient identifier, a sender identifier, and/or the like. According to some embodiments of the invention, the transaction information also includes instructions to notify one or more transaction parties or third parties about the progress of the transaction. Thus, the system also includes various components to perform these functions.

The system includes, for example, a notification unit 116, which may be a voice response unit, a call center, or the like. The notification unit may be manned or unmanned. The notification unit is in communication with the host computer system 102. This enables the notification unit 116 to receive instructions for notifying money transfer parties. The notification unit contacts the parties, in some embodiments through a communication network 118, which may be, for example, a PSTN (public switched telephone network). Thus, through the network 118, the notification unit 116 may contact a money transfer party by placing a telephone call to the party's telephone 120. In other embodiments, the notification unit 116 may place a call through a wireless transmission system 122 to the party's cellular phone 124 or other wireless device in ways well known to those skilled in the art. The notification may be a voice message or a data message (e.g., text message). Other embodiments exist.

In some embodiments, the notification unit 116 or the host computer system 102 sends a message (e.g., email) to a personal computer 126 of the party. The personal computer 126 may be any of the aforementioned computing devices.

In still other embodiments, the notification unit 116 may send a notification using either of the aforementioned networks 104, 118 to a PDA 128 of the recipient. The notification may be, for example, an email, a text message, or the like.

Although a postal delivery element is not shown, the host computer system 102 or the notification unit 116 may initiate a paper notification (e.g., letter, mailgram, telegram, or the like) to be posted to the party being notified. Those skilled in the art will appreciate many other examples in light of this disclosure.

The foregoing describes but one possible example of a money transfer system incorporating the elements for accomplishing the notification process. The system may be used to notify any number of parties to a transaction. It is to be appreciated, however, that some embodiments of the invention may include a very limited number of the aforementioned system elements yet still perform the functions described herein as will be appreciated by those skilled in the art.

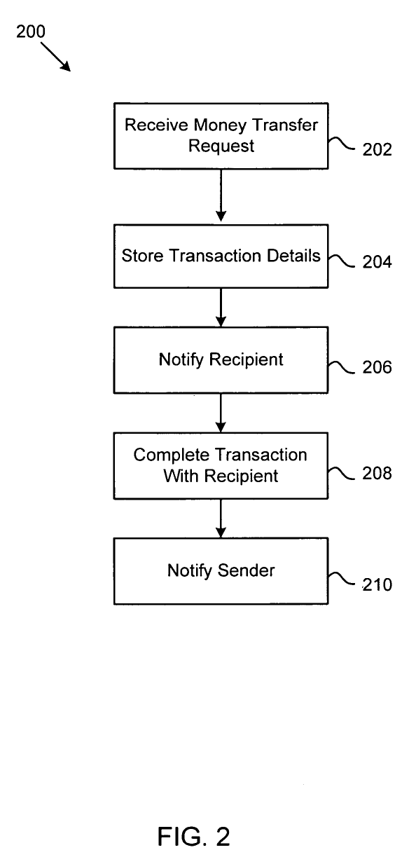

Having described a system according to embodiments of the system, attention is directed to FIG. 2, which illustrates a method 200 of notifying parties to or interested in a financial transaction, in this case a money transfer. The method may be implemented in the system 100 of FIG. 1 or other suitable system. It should be appreciated that other embodiments may include more, fewer, or different steps than those described herein. Further, methods according to other embodiments may traverse the steps in orders different than that shown here, as will be appreciated by those skilled in the art in light of this disclosure.

The method 200 begins at block 202 when a sender initiates a money transfer request. The money transfer request may be initiated by the sender in any of a number of well known ways using the previously-described transaction processing devices from the system 100 or other suitable devices for initiating a money transfer. The request is received by the host computer system and a record is created at block 204.

Block 202 also may represent the creation of a stored value account, prepaid account, or the like, or the addition of funds to it.

The request may include an indication that the sender wants to be notified when the recipient picks up the money. The request also may include an indication that the sender wants the recipient to be notified that the money is available for receipt. The sender also may request that a third party be notified. The request may include a selection of the form that the notification should take and the necessary contact information. In the case of prepaid, stored value accounts, and the like, the request may be for other types of notifications, as will be described in greater detail below.

The sender also may record a video-gram, gift-gram, or other personalized message for the recipient. The message may be included with the notification to be described hereinafter or may comprise the notification itself.

In some embodiments, the sender and/or the recipient may have a pre-established profile with a preferred notification method and the necessary contact information. The profile may be stored, for example, at the host computer system, on a card or other presentation instrument, and/or the like. If a card or other presentation instrument is used, the profile may be read from the item by a point-of-sale device, or information on the card may be used to access the information from a host computer system. Thus, even if the sender does not select to be notified or have the recipient notified, the presence of the predefined profile may nevertheless trigger a notification, as will be described in more detail hereinafter.

If the sender requested the recipient to be notified and/or the recipient has a pre-established profile, the host computer system initiates a notification at block 206. The host computer system may send the notification itself, or the host computer system may initiate the notification by sending required information to a notification service, such as the notification unit 116 of FIG. 1, which may be operated by a third party.

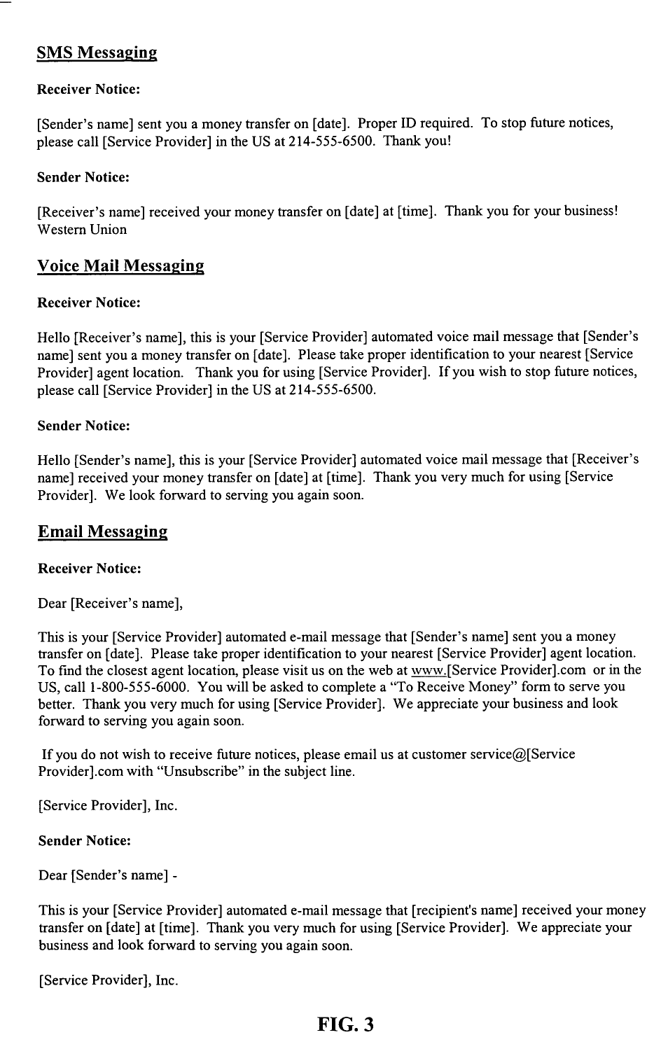

Several exemplary recipient notifications are shown in FIG. 3. The recipient notification may include any of a number of items:
how much money or other value was sent;
what method of transfer the sender used;
when the money will be available;
the closest location to pick up the money or instructions for finding it;
instructions for picking up the money (e.g., present proper identification) and alternatives for receiving or using the money (e.g., having a check or money order mailed, redirecting the money to another recipient, sending the money to an account, receiving the money in a different currency or form of value, paying a bill, etc.);
instructions for opting out of future notifications;
instructions for sending a personalized response to the sender or other party (e.g., a “thank you” telegram, a “payment received” message to a debtor;
a contact phone number or email address for customer service; and/or
the like.
   The recipient notification may take any of the previously-described forms, such as email, text message, telephone notification, or the like, and may include audio and/or video messages from the sender or other party.

If the notification is by telephone, the notification may be an automated voice or a human voice. If the recipient does not answer, multiple attempts may be made to contact the recipient, possibly up to a default number of attempts or for a pre-determined period of time. If the default number of attempts has been unsuccessful, then an alternative means for contacting the recipient may be attempted. The default secondary means may be provided by the sender or by the recipient, in a profile, for example. If a voice mail service of the recipient answers, then a message may be left. Those skilled in the art will appreciate may other examples in light of this disclosure.

At block 208, the receive transaction is accomplished. This may involve the recipient presenting himself to a money transfer location, such as any of those described above with respect to FIG. 1, and receiving the money. Alternatively, the sender may use electronic means to direct the money to an account, request a mailed check or money order, or direct the funds to another recipient. Many other possibilities exist.

At block 208, the recipient may initiate one or more notifications. The notifications may be to the sender or other interested party and may include video and/or audio, and/or the like.

At block 210, the sender is notified that the recipient received the funds. As with the recipient notification, the sender's notification may be initiated by the host computer system. The host computer system may accomplish the notification itself or engage a notification unit to accomplish the notification. As with the recipient notification, the sender notification may be any of the aforementioned means, several of which are illustrated in FIG. 3. Even though the sender may have initiated the notification, the notification may, nevertheless, include instructions for opting out of future notifications.

The notification to the sender may include other information. For example, the notification may include:
the location at which the recipient picked up the money;
the currency or other form in which the recipient received the money;
the amount of value the recipient received, especially if the recipient received value in a currency or form of value different from that which the sender remitted;
whether the recipient experienced any customer service issues in picking up the money; and the like.

Any notification provided herein may be accomplished by the money transfer service provider itself, or the money transfer service provider may use the services of another entity (e.g., a notification service) to accomplish the notification. Further, notification services are not limited to particular money transfer channels. For example, regardless of whether the sender initiates the transfer at a kiosk, personal computer, retail location or other, and regardless of how the recipient picks up the funds, the notifications may be made. Further still, even if the sender did not request to be notified, the recipient may initiate a notification to the sender. Such notifications may be particularly useful in instances wherein the recipient is a creditor that wishes to advice the sender that the recipient will not initiate collections or take other actions since the money has been received.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to notifying parties to money transfer transactions. Embodiments of the present invention apply to transfers of any kind of value and also may include notifications such as notifying a gift card/stored value card giver when a recipient uses the card, notifying a gift card/stored value card holder when the card balance is getting low, notifying a pre-paid cellular phone user when the available usage balance is low or has reached a pre-determined threshold, and the like. Accordingly, the above description should not be taken as limiting the scope of the invention, which is defined in the following claims.

1. A method of transferring funds from a sender to a recipient, comprising:
receiving at a transfer location a transfer request from the sender, wherein the transfer request includes a notification request to notify the sender when the recipient receives the funds;
sending the transfer request to a host computer system;
receiving at a transfer location a request from the recipient to receive the funds;
receiving a message at the host computer system that the recipient received the funds; and
sending from the host computer system a notification to the sender that the recipient received the funds.

2. The method of claim 1, wherein the notification to the sender comprises a selection from the group consisting of email, text message, letter, and telegram.

3. The method of claim 1, wherein the notification to the sender comprises a telephone call.

4. The method of claim 3, wherein the telephone call is not received by the sender, the method further comprising attempting to contact the sender a plurality of times over a specified period of time.

5. The method of claim 3, further comprising leaving a message on a voice message system of the sender.

6. A method of transferring funds from a sender to a recipient, comprising:
receiving at a transfer location a transfer request from the sender, wherein the transfer request includes a notification request to notify the recipient that funds are available for pick up;
sending the transfer request to a host computer system;
sending a message from the host computer system to the recipient that the funds are available for pick up.

7. The method of claim 6, wherein the message to the recipient includes a selection for the recipient to opt out of future notifications.

8. The method of claim 6, wherein the message to the recipient comprises a selection from the group consisting of email, telephone call, text message, letter, and telegram.

9. The method of claim 6, further comprising:
receiving at a transfer location a request from the recipient to receive the funds;
receiving a message at the host computer system that the recipient received the funds; and
sending from the host computer system a message to the sender that the recipient received the funds.

10. A system for notifying parties to a transfer of value, comprising:
a host computer system configured to receiving a request to transfer value from a sender to a recipient, wherein the request includes information that identifies the recipient, the form of value, and instructions to notify a party to the transaction when an event has occurred;
a notification unit configured to comply with the notification request; and
a least one transfer location configured to receive value from a sender and remit value to a recipient.

11. The system of claim 10, wherein the value comprises a selection from the group consisting of money, airline miles, credits, long distance time, wireless telephone minutes, movie rentals, and customer loyalty points.

12. The system of claim 10, wherein the transfer location comprises a selection from the group consisting of point-of-sale device, personal computer, automated teller machine, and multi-purpose kiosk.

13. The system of claim 10, wherein the notification unit is configured to:
place a telephone call to one of the parties;
leave a message if a voice mail system answers the call;
place multiple calls until a person or a voice mail system answers; and
provide an automated human voice message to an answering party.

14. The system of claim 10, wherein the value comprises money and the notification request comprises a request from the sender to be notified when the recipient receives the money.

15. A computer-readable medium having stored thereon computer-executable instructions for performing a method, the method comprising:
receiving a value transfer request from a sender;
storing at least a portion of the request as a transfer;
receiving a message that a recipient has received the value; and
notifying a party to the transaction regarding the progress of the transaction.

16. The computer-readable medium of claim 15, wherein notifying a party to the transaction regarding the progress of the transaction comprises notifying the recipient that value is available for receipt.

17. The computer-readable medium of claim 15, wherein notifying a party to the transaction regarding the progress of the transaction comprises notifying the sender that the recipient received the value.

18. A method of transferring value, comprising:
at a first transfer location, receiving a request to transfer value, wherein the request comprises information that identifies the recipient, the form of value, and instructions to notify a party to the transaction when an event has occurred;
sending at least a portion of the information to a host computer system;
at a second transfer location, receiving a request from the recipient to receive the value;
fulfilling the receive request; and
complying with the notification instruction.

19. The method of claim 18, wherein complying with the notification instruction comprises notifying the recipient that value is available for receipt.

20. The method of claim 18, wherein complying with the notification instruction comprises notifying the sender that the recipient received the value.

21. A method of providing one or more notifications to one or more parties related to a transaction, comprising:
at a first point-of-sale, receiving transaction initiation information from a first party to the transaction;
sending the transaction initiation information to a host computer system;
creating a record at the host computer system relating to the transaction;
at a second point-of-sale, receiving transaction settlement information from a second party, wherein the transaction settlement information may be used to settle at least a portion of the transaction;
sending the transaction settlement information to the host computer system; and
updating the record at the host computer system;
wherein either the transaction initiation information or the transaction settlement information comprises a notification request, the method further comprising:
storing information relating to the notification request in the record at the host computer system; and
complying with the notification request.

22. The method of claim 21, wherein the first party and the second party comprise the same party.

23. The method of claim 21, wherein storing information relating to the notification request in the record at the host computer system comprises storing a multimedia file created by either the first party or the second party.

24. The method of claim 21, wherein complying with the notification request comprises a selection from the group consisting of:
sending a message to a sender that a recipient has picked up money;
sending a message to a recipient that a sender has deposited money for the recipient to pick up;
sending information to a third party relating to the transaction;
sending a message to a card holder that a balance is below a pre-determined threshold;
sending a message to an account holder that a balance is below a pre-determined threshold;
sending transaction activity information to a party; and
sending a personalized message from one of the parties to another of the parties.

25. The method of claim 21, wherein the transaction basis comprises a measure of value selected from the group consisting of money, airline miles, credits, long distance time, wireless telephone minutes, movie rentals, and customer loyalty points.

26. The method of claim 21, wherein complying with the notification request comprises sending a notification in a form selected from the group consisting of email, telephone call, text message, letter, and telegram.
